(19) United States
(12) Patent Application Publication
(10) Pub. No.: US 2022/0045707 A1
(43) Pub. Date: Feb. 10, 2022

(54) VR GO CASE

(71) Applicants: Hendrix Thomas Dyke, Rawhay, NJ (US); Shakira Nida Hogan, Rawhay, NJ (US)

(72) Inventors: Hendrix Thomas Dyke, Rawhay, NJ (US); Shakira Nida Hogan, Rawhay, NJ (US)

(21) Appl. No.: 17/346,259

(22) Filed: Jun. 13, 2021

Related U.S. Application Data
(60) Provisional application No. 63/045,800, filed on Jun. 29, 2020.

(51) Int. Cl. H04B 1/3888; H04M 1/02; H04M 1/04

(52) U.S. Cl. CPC H04B 1/3888; H04M 1/04; H04M 1/026

(57) ABSTRACT

The present concept relates to virtual reality and creating the ability for people to experience virtual reality “VR” content on their mobile devices in a much more fluid way than the options that are currently available.

### CROSS-REFERENCE TO RELATED APPLICATIONS

This application claims the benefit of priority under 35 U.S.C. § 119(e) to U.S. provisional application No. 63/045,800 filed Jun. 29, 2020. Each of the aforementioned applications is incorporated herein by reference in its entirety.

### BACKGROUND

Virtual reality is a fast-growing area of interest for many gaming and media enthusiasts. The ability to put on a VR headset or play a game on a phone utilizing motion tracking is a new and exciting area that is steadily growing in both popularity and potential.

Currently the options for VR headsets are limited as you are subjected to buying a high-end standalone headset or a bulky headset that provides the need to remove your phone case altogether.

These things considered, this invention solves this problem for both the casual user and VR enthusiast by combining headsets and phone cases to turn virtual reality into something that you can experience anytime without hindrance.

### SUMMARY OF THE INVENTION

Briefly described, this invention provides a cell phone user with a case for the cell phone in which the case contains a storage compartment.

The features and advantages of this invention will become apparent from the following detailed description.

A phone case that also allows users to be able to experience virtual reality content by utilizing a detachable VR headset that can be flipped over the phone and replaced at the users' convenience.

### BRIEF DESCRIPTION OF THE DRAWINGS

FIG. 1 shows a front view of the go case with the headset in an open position allowing the user to see the screen through the built-in lens.

FIG. 2 shows a back view of the go case in a closed position with the headset inside the detachable pocket.

FIG. 3 shows the back of the detachable pocket with parallel adhesive strips.

FIG. 4 shows the front of the detachable pocket with an interchangeable button for security.

FIG. 5 shows the back of the go case without the detachable pocket highlighting the parallel adhesive strips.

FIG. 6 shows the inside of the detachable pocket highlighting the adhesive strips that hold the pocket together.

FIG. 7. Shows the inside of the detachable pocket partially unfolded to depict where the compartment for the headset would be.

FIG. 8. Shows the inside of the detachable pocket fully unfolded depicting where the compartment for the headset would be.

FIG. 9. Shows the inside of the detachable pocket with the headset partially unfolded to depict how the headset opens around the case.

FIG. 10. Shows the inside of the detachable pocket with the headset fully unfolded to depict how the headset opens around the case.

FIG. 11. Shows the back of the go case with the detachable pocket in a closed position so that the headset is covered.

FIG. 12. Shows the side of the case from the top view of the detachable pocket depicting where the headset would sit in relation to the phone.

FIG. 13. Shows the side of the case from the bottom view of the detachable pocket.

FIG. 14. Shows the back view of FIG. 6 with the cell phone attached.

FIG. 15. Shows the back view of FIG. 7 with the cell phone attached.

FIG. 16 Shows the back view of FIG. 8 with the cell phone attached.

FIG. 17 shows the back of FIG. 9 with the phone attached.

FIG. 18 shows FIG. 1 from the back view.

FIG. 19. Shows FIG. 1 from the top view.

There are many models of cell phones, and each model most likely will have a case to fit that model. The cases can have many different dimensions and may be square, rectangular etc., in shape. The cell phone case of this invention can be sized and configured to work with these various models of cell phones.

The rigid cell phone case can be constructed of different materials, such as leather, a hard-molded plastic material, artificial leather (such as Naugahyde), vinyl, a rubber material, silicon, a woven textile, a fabric, etc.

The detachable pocket can be constructed of different materials such as leather, hard molded plastic, artificial leather (such as Naugahyde), vinyl, a rubber material, silicon, a woven textile, a fabric, etc.

The invention has been described in detail with particular reference to certain embodiments, but variations and modifications of these embodiments can be made without departing from the spirit and scope of the invention.

### DETAILED DESCRIPTION OF PREFERRED EMBODIMENTS

This is an abstract concept combining the existing technologies of virtual reality goggles and cell phone cases simplifying the process users have to go through to experience virtual reality content on their mobile devices.

The cell phone case would be built using a variation of materials with a foldable compartment where the goggles would be hidden until they are in use by the user.

The compartment would have a latch that when opened allows for the goggles to be flipped over the back of the phone and extend in front of the phone screen to allow users to experience VR content such as games, movies, or other experiences available on their mobile device.

A version of the case would be constructed to allow for an external VR headset attachment that can slide on a bar or be attached with a pin compartment allowing for the replacement of headsets based on the users preference.

A version of the phone case could also allow for an open compartment specially fit to secure VR goggles for replacement.

The phone case could allow for an extension of the case itself that includes an attachment to cover the front of the screen and allow for a hands-free experience with the use of elastic bands.

### DETAILED DESCRIPTION OF THE INVENTION

The present invention provides a cell phone case having a detachable compartment for storing a virtual reality headset. This invention provides a cell phone case comprising:

(a) a rigid container comprised of joinable front, back and side portions:

(b) two adhesive strips attached to the back portion of the rigid container

(c) a detachable compartment joined by adhesive strips to the back portion of the rigid container.

wherein the compartment is opened and closed with an interchangeable latch; and

(d) a space located in the compartment and adapted to hold a virtual reality headset

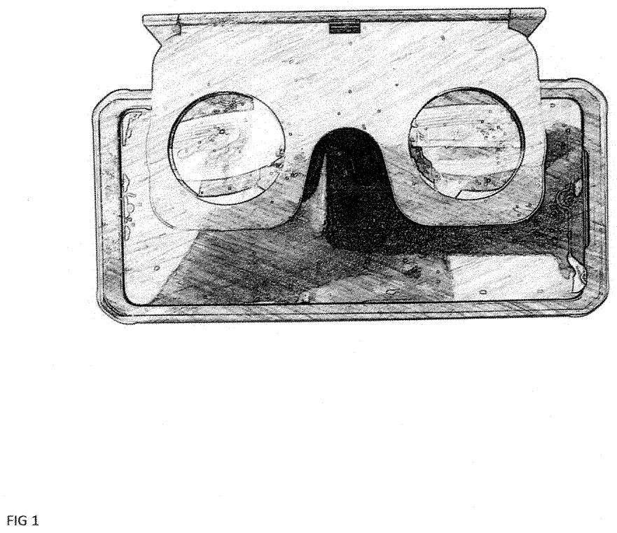

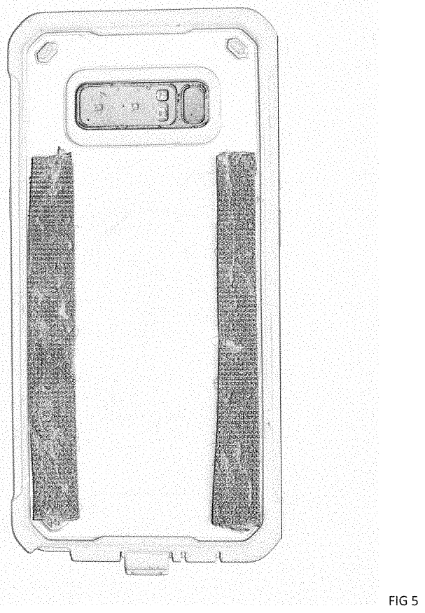

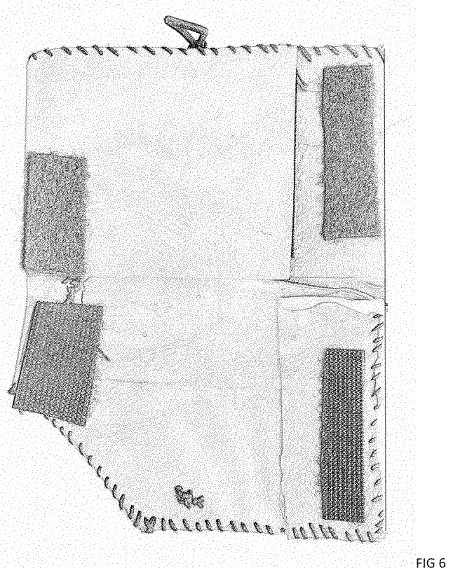

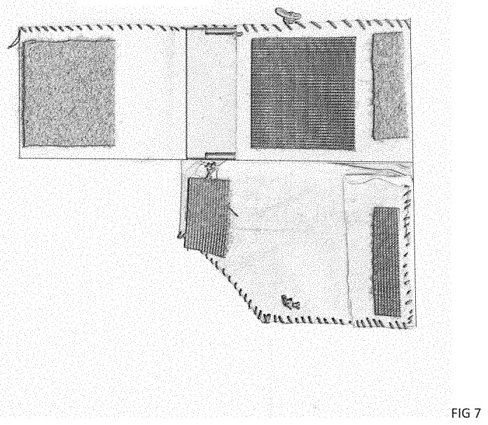

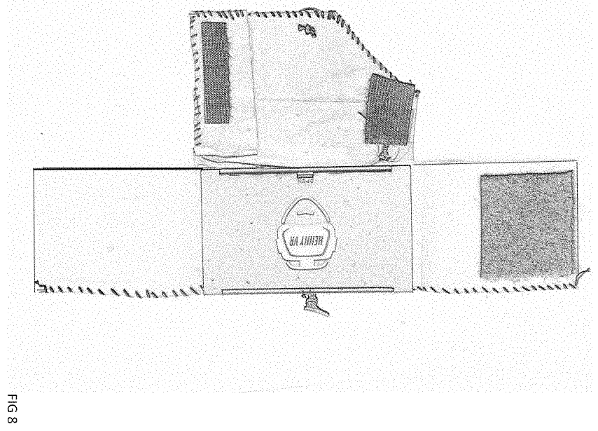

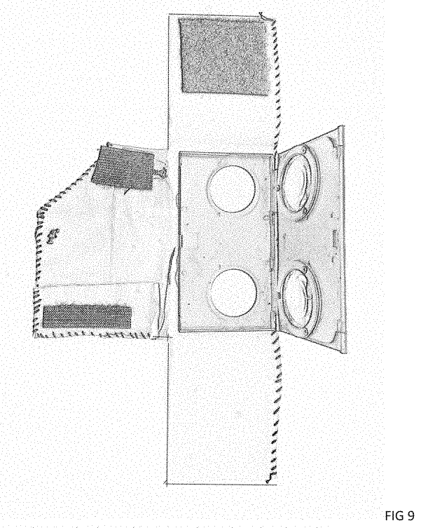

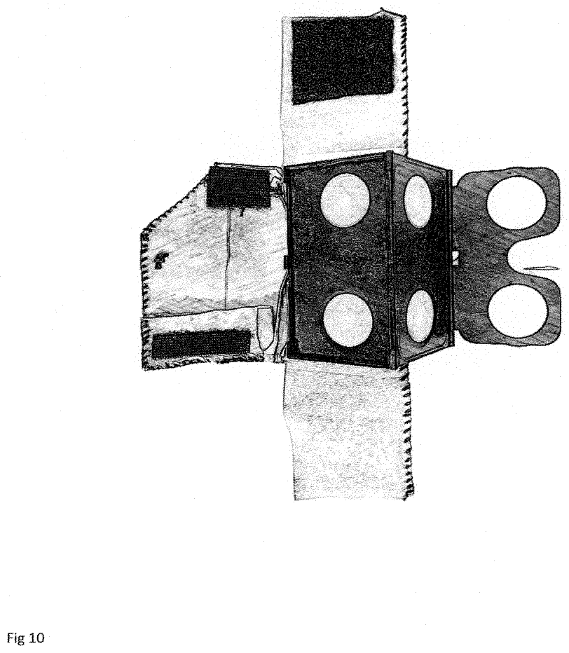

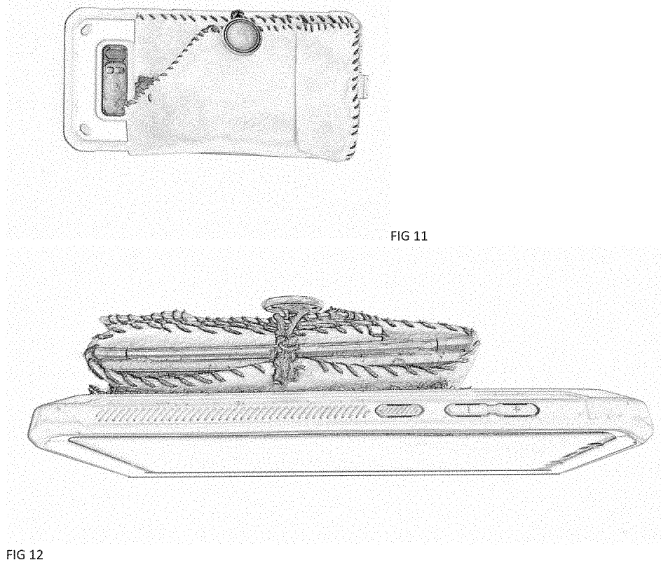

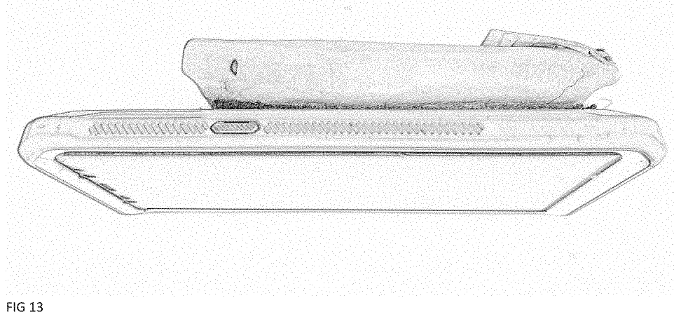

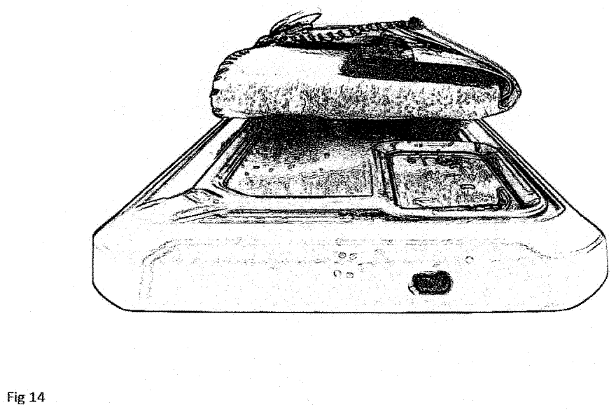

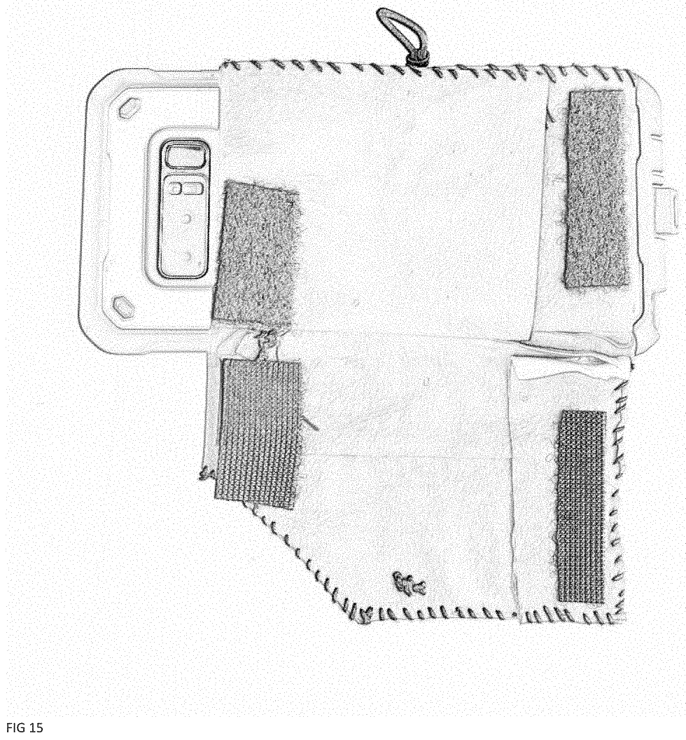

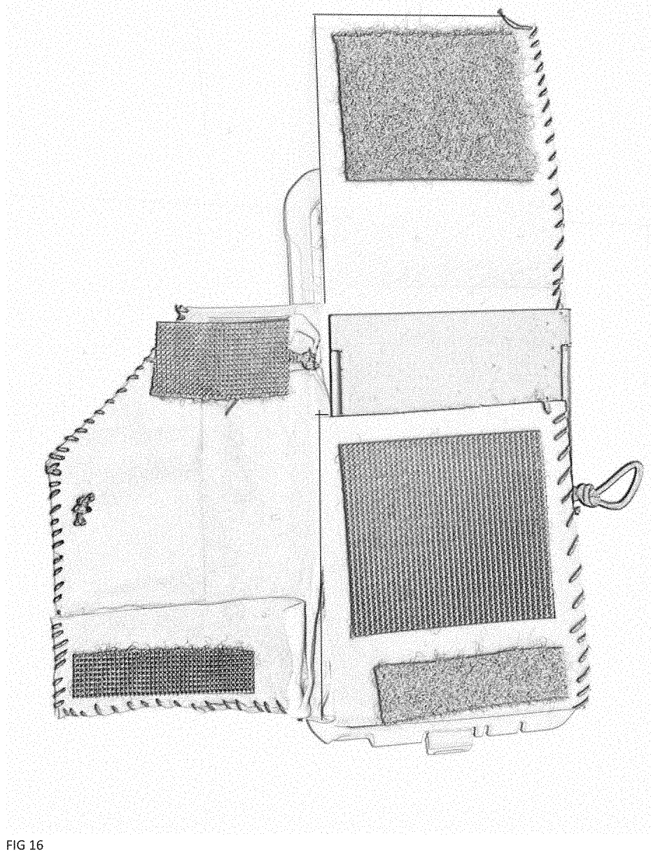

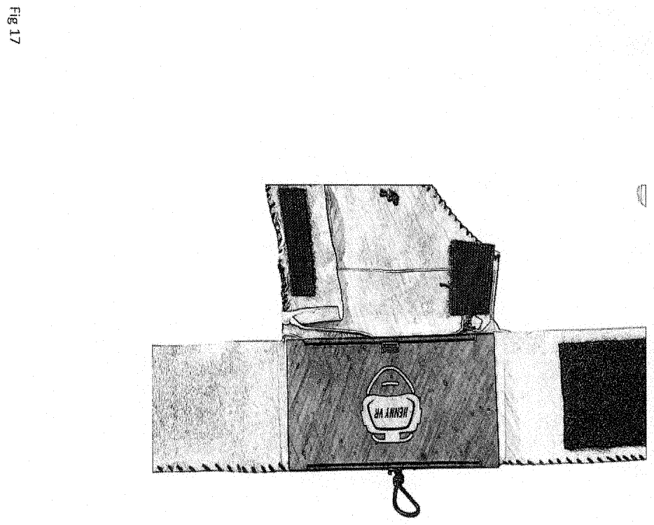

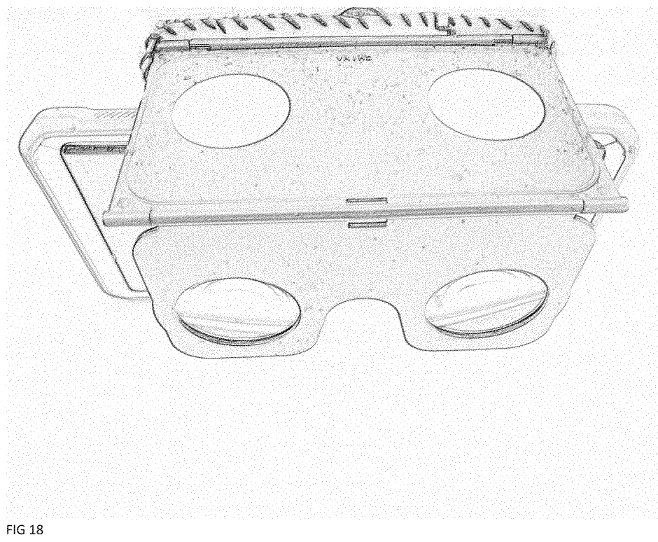

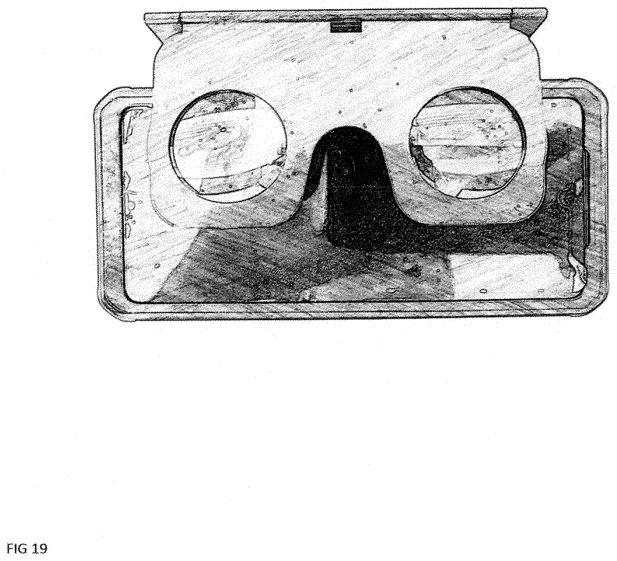

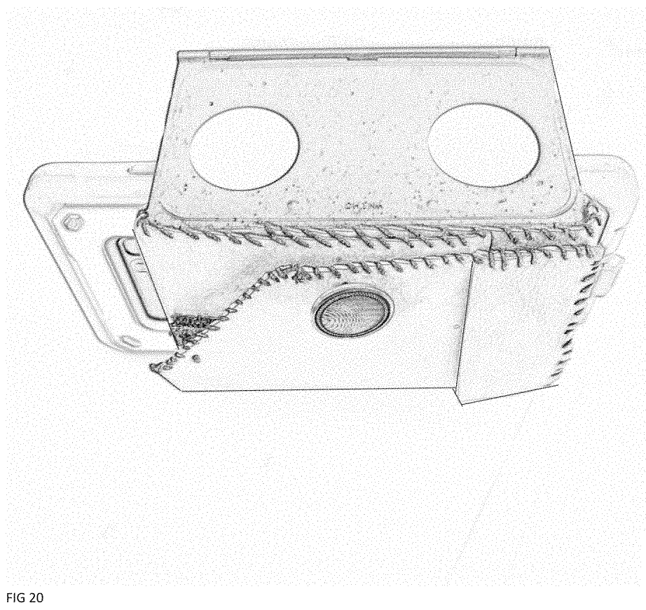

Preferred embodiments of this invention are shown in FIGS. 1-19.

Referring now to the drawings, in which like numbers represent like elements. FIG. 1 shows a side view of the cell phone case 1 of this invention in an open position. The mirror 2 (reflective device) has been moved out to the open position. Mirror 2 is attached to the inside portion of slidable cover 3. Storage compartment 4 is closed when mirror 2 is moved down to the closed position.

The cell phone case 1 shown in FIG. 1 is comprised of front portion 5, back portion 6 and side portion 7 (not shown), which are joined by a friction fit. (These portions of the cell phone case can be joined by other means, such as by use of an adhesive or glue material.)

FIG. 1. when the slidable cover 3 is moved to the open position to expose mirror 2, credit card 8 slides (or can be removed) from storage compartment 4.

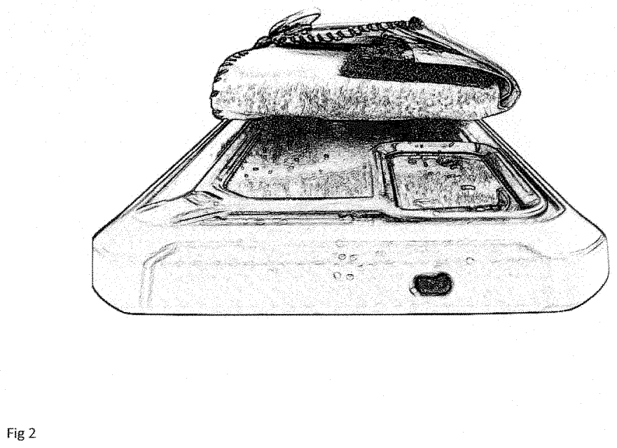

FIG. 2 shows a front view of the cell phone case 1 (shown in FIG. 1) with slidable cover 3 and aperture 9. When slidable cover 3 is in the closed position (i.e., mirror 2 is not exposed), aperture 9 will be positioned to not interfere with the *camera function (if present) of the cell phone.

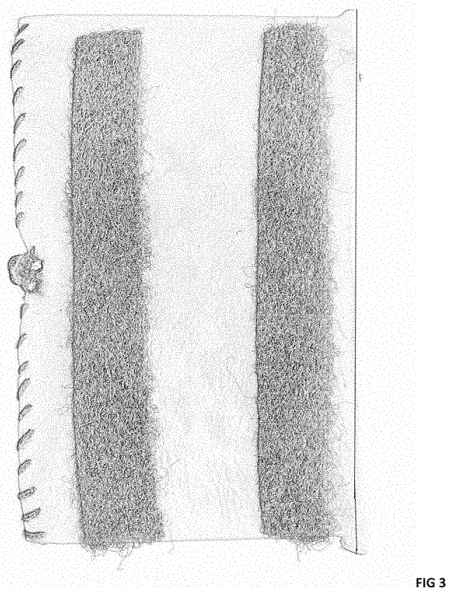

With reference to FIG. 3, cell phone case 1 is shown in the closed position so that credit card 8 is located in storage compartment 4, and mirror 2 is not exposed.

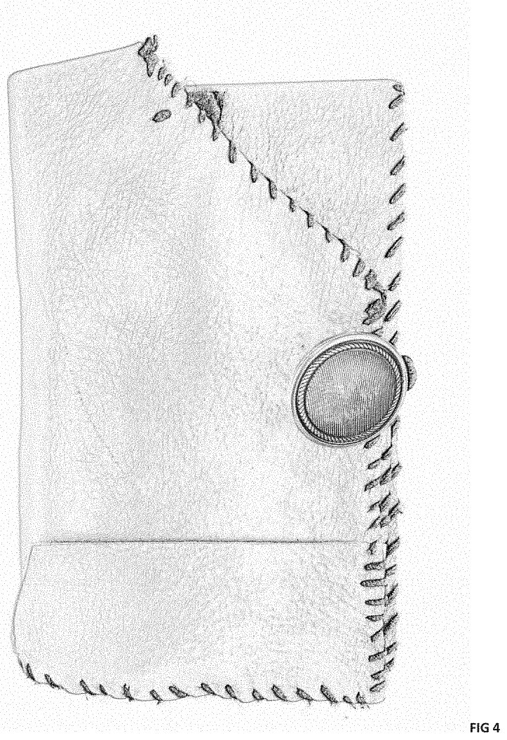

FIG. 4 shows a back view of cell phone case 1 in which slidable cover 3 is in the open position, and aperture 9 is not in cooperation with the camera function (not shown) of the cell phone.

In this invention, the mirror must not interfere with the camera function of the cell phone. Thus, the mirror must be smaller than the outside dimensions of the cell phone case. Additionally, the storage compartment must not interfere with the camera function of the cell phone and must be smaller than the outside dimensions of the cell phone case.

As can be seen from FIGS. 1-4, the mirror and storage compartment (holding the credit card) are exposed when the back is opened. Both the slidable cover and storage compartment are integrated into the cell phone case of this invention.

There are many models of cell phones, and each model most likely will have a case to fit that model. The cases can have many different dimensions and may be square, rectangular etc., in shape. The cell phone case of this invention can be sized and configured to work with these various models of cell phones.

The rigid cell phone case can be constructed of different materials, such as leather, a hard-molded plastic material, artificial leather (such as Naugahyde), vinyl, a rubber material, silicon, a woven textile, a fabric, etc.

The detachable pocket can be constructed of different materials, such as leather, a hard-molded plastic material, artificial leather (such as Naugahyde), vinyl, a rubber material, silicon, a woven textile, a fabric, etc.

This invention allows a cell phone user to eliminate the necessity to carry a virtual reality headset and device as separate units

The invention has been described in detail with particular reference to certain embodiments, but variations and modifications of these embodiments can be made without departing from the spirit and scope of the invention.

1. A case for a cellular telephone, wherein the case comprises:
(a) a rigid container comprised of joinable front, back and side portions.
(b) a demountable pocket compartment attached to the back portion of the rigid container; and
c) a space located in the compartment and adapted to hold a virtual reality viewer

2. A case as defined by claim 1, wherein the rigid container is formed from a plastic material.

3. A case as defined by claim 1, wherein the rigid container is formed from an artificial material.

4. A case as defined by claim 1, wherein the rigid container is formed from a natural material.

5. A case defined by claim 1, wherein the compartment is formed from a plastic material.

6. A case defined by claim 1, wherein the compartment is formed from an artificial material.

7. A case defined by claim 1, wherein the compartment is formed from a natural material.

8. A case defined by claim 1, wherein the compartment is attached to the back portion of the rigid container by magnet.

9. A case defined by claim 1, wherein the compartment is attached to the back portion of the rigid container by hook and loop fastener.

10. A case as defined by claim 1, wherein the front, back and side portions are joined by a friction fit.

11. A case as defined by claim 1, wherein the front, back and side portions are joined by an adhesive material.
